(19) United States
(12) Patent Application Publication
(10) Pub. No.: US 2025/0392429 A1
(43) Pub. Date: Dec. 25, 2025

(54) HIGH SPEED CSI PREDICTION USING SHIFTED WINDOW TRANSFORMER

(71) Applicant: Samsung Electronics Co., Ltd., Suwon-si (KR)

(72) Inventors: Yu Zhang, Frisco, TX (US); Daoud Burghal, San Jose, CA (US); Hao Chen, Allen, TX (US); Yan Xin, Princeton, NJ (US); Fan Zhang, Plano, TX (US); Tiexing Wang, Melissa, TX (US); Yang Li, Plano, TX (US)

(21) Appl. No.: 19/091,591

(22) Filed: Mar. 26, 2025

Related U.S. Application Data
(60) Provisional application No. 63/664,115, filed on Jun. 25, 2024.

(51) Int. Cl. H04L 5/00; H04B 7/06; H04L 25/02

(52) U.S. Cl. CPC H04L 5/0051; H04B 7/0626; H04L 25/0204

(57) ABSTRACT

Methods and apparatuses for a high speed CSI prediction using a shifted window transformer in wireless communication systems are provided. The methods of BS comprise: receiving an SRS; determining, based on channel pixels including an angle and a delay, at least one attention score associated with an image; identifying, based on the at least one attention score, correlation patterns of the images; performing, based on the correlation patterns, a shifted window attention operation for uplink channel estimation; and predicting, based on the shifted window attention operation, CSI from the SRS for the uplink channel estimation.

### CROSS-REFERENCE TO RELATED APPLICATIONS AND CLAIM OF PRIORITY

The present application claims priority to U.S. Provisional Patent Application No. 63/664,115, filed on Jun. 25, 2024. The contents of the above-identified patent documents are incorporated herein by reference.

### TECHNICAL FIELD

The present disclosure relates generally to wireless communication systems and, more specifically, the present disclosure relates to a high speed channel state information (CSI) prediction using a shifted window transformer in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a high speed CSI prediction using a shifted window transformer in wireless communication systems.

In one embodiment, a base station (BS) in a wireless communication system is provided. The BS comprises a transceiver configured to receive a sounding reference signal (SRS). The BS further comprises a processor operably coupled with the transceiver. The processor configured to: determine, based on channel pixels including an angle and a delay, at least one attention score associated with an image, identify, based on the at least one attention score, correlation patterns of the images, perform, based on the correlation patterns, a shifted window attention operation for uplink channel estimation, and predict, based on the shifted window attention operation, CSI from the SRS for the uplink channel estimation.

In another embodiment, a method of a BS in a wireless communication system is provided. The method comprises: receiving an SRS; determining, based on channel pixels including an angle and a delay, at least one attention score associated with an image; identifying, based on the at least one attention score, correlation patterns of the images; performing, based on the correlation patterns, a shifted window attention operation for uplink channel estimation; and predicting, based on the shifted window attention operation, CSI from the SRS for the uplink channel estimation.

In yet another embodiment, a non-transitory computer-readable medium is provided. The computer-readable medium comprises program code, that when executed by at least one processor, causes an electronic device to: receive an SRS; determine, based on channel pixels including an angle and a delay, at least one attention score associated with an image; identify, based on the at least one attention score, correlation patterns of the images; perform, based on the correlation patterns, a shifted window attention operation for uplink channel estimation; and predict, based on the shifted window attention operation, CSI from the SRS for the uplink channel estimation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates an example of shifted window attention according to various embodiments of the present disclosure;

FIG. 8 illustrates an example of a general structure of CSI prediction model according to various embodiments of the present disclosure;

FIG. 9 illustrates an example of two-step prediction model according to various embodiments of the present disclosure;

FIG. 10 illustrates examples of direct two-step prediction model and retrainable second-step prediction according to various embodiments of the present disclosure;

FIG. 11 illustrates an example of TTI level prediction according to various embodiments of the present disclosure; and

FIG. 12 illustrates a flowchart of BS method for a high speed CSI prediction using a shifted window transformer according to various embodiments of the present disclosure.

### DETAILED DESCRIPTION

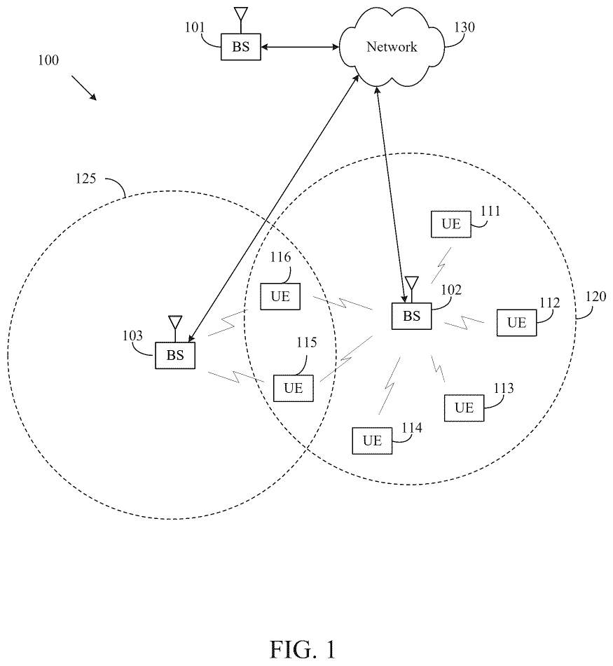

FIG. 1 through FIG. 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v17.4.0, “NR; Physical channels and modulation”; 3GPP TS 38.214 v17.4.0, “NR; Physical Layer Procedures for data”; and 3GPP TS 38.331 v17.3.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signals and/or information for supporting a high speed CSI prediction using a shifted window transformer, at the gNBs 101-103, in wireless communication systems. In certain embodiments, and one or more of the gNBs 101-103 includes circuitry, programing, or a combination thereof, to support a high speed CSI prediction using a shifted window transformer in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

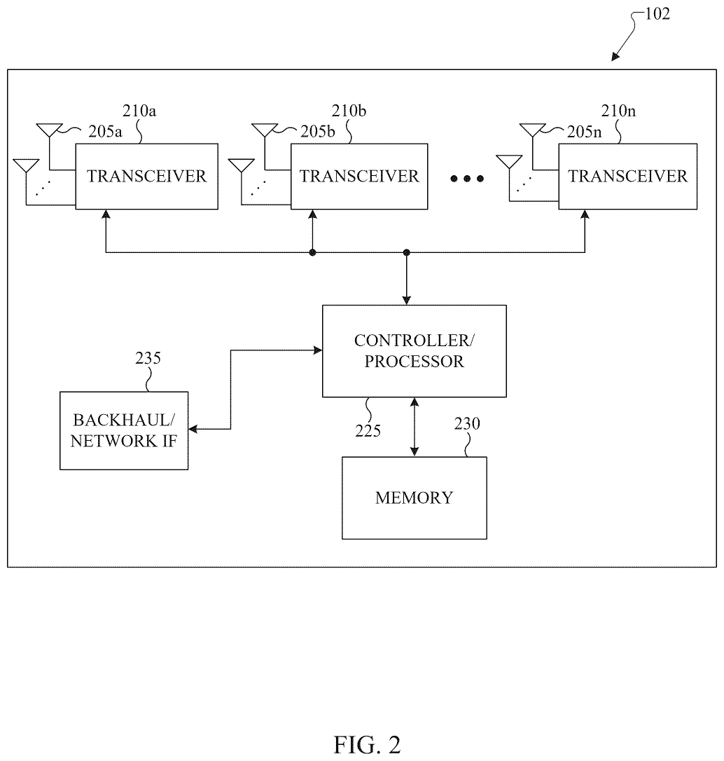

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a high speed CSI prediction using a shifted window transformer in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

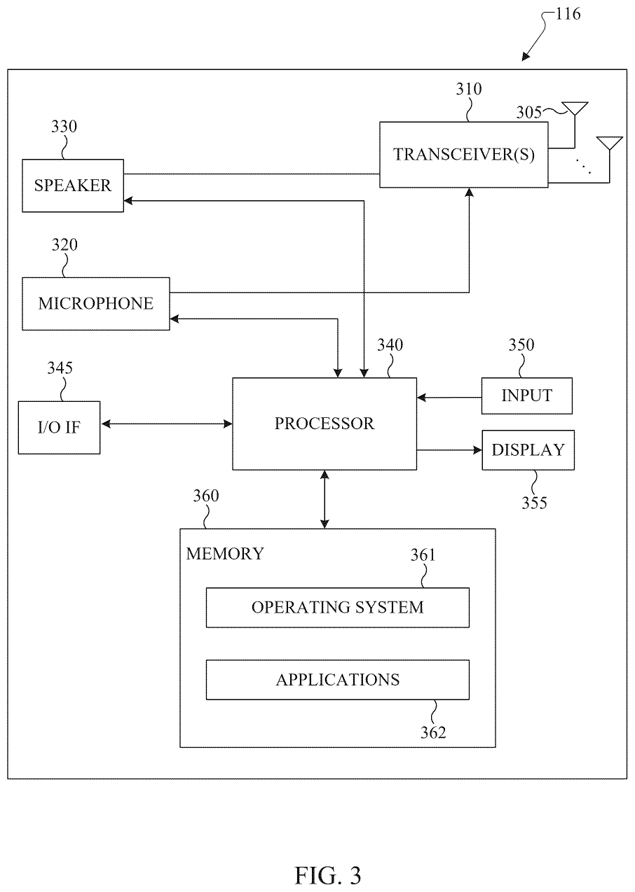

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate signals and/or information for supporting a high speed CSI prediction using a shifted window transformer, at gNB 101-103, in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

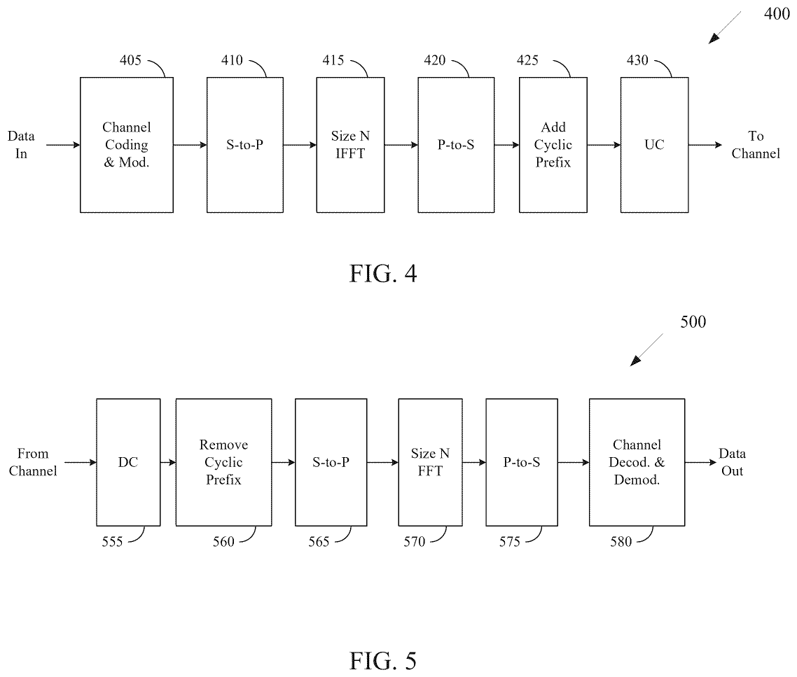

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process can comprise NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, SRS enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

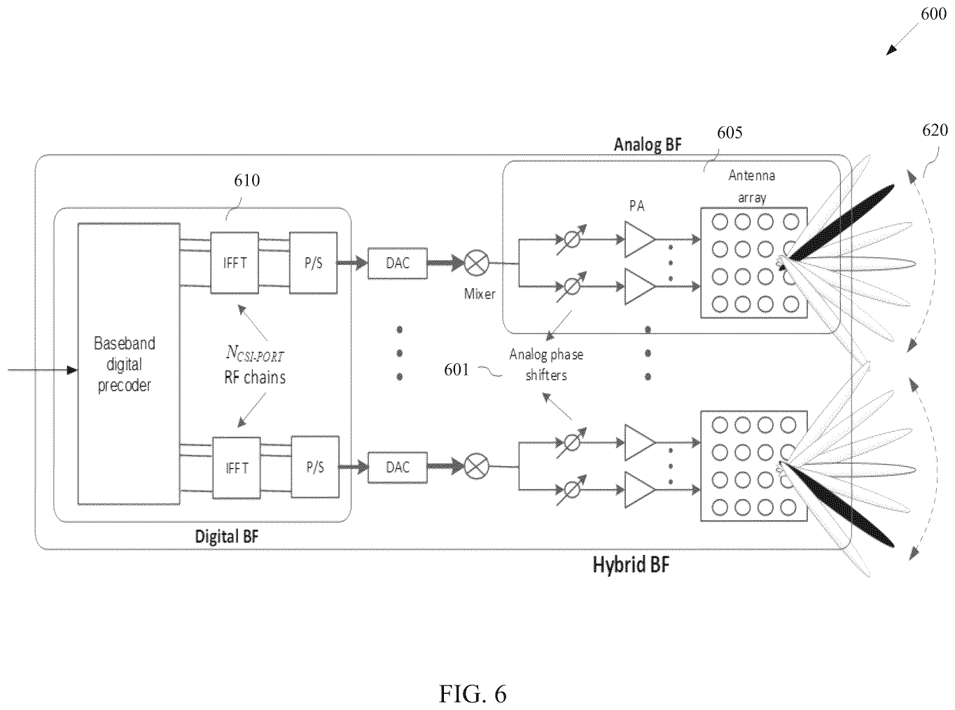

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the 02 absorption loss around 60 GHz frequency (˜10 dB additional loss @ 100m distance), larger number of and sharper analog beams (hence larger number of radiators in the array) may be needed to compensate for the additional path loss.

Massive MIMO (mMIMO) is an important technology to improve the spectral efficiency of 4G and 5G cellular networks. A number of antennas in mMIMO is typically much larger than a number of UEs, which allows BS to perform multi-user downlink (DL) beamforming to schedule parallel data transmission on the same time-frequency resources. However, its performance depends heavily on the quality of CSI at a BS. It has been recently verified that the MU-MIMO performance degrades with UE mobility. CSI prediction can be used to combat the CSI aging, thus the system can reduce the impact of processing delay and possibly the overhead. These problems are important to address especially at higher UE mobilities.

Data-driven (e.g., AI based) approaches can be utilized for CSI prediction, allowing model flexibility and applicability to the environment of interest. Currently, AI based channel prediction is one of the promising study cases in 3GPP for Rel-18. However, such techniques suffer from dataset bias, e.g., applicable operation speed (doppler) range can be limited to the observed speeds in the original dataset. The present disclosure provides a technique to enhance the generalizability of data-driven CSI prediction to speeds outside the dataset range. Some corresponding signaling details of these methods are also discussed in this disclosure. Additionally, methods to enhance the training of the data-drive solutions are provided.

In MIMO system, CSI becomes out-of-dated quickly for in highly dynamic environments, this is especially for mMIMO in which the BS relies on sounding reference signal sent by UE in the network. The UE also relies on scheduled pilot transmission (e.g., CSI-RS) by the BS. This greatly reduce the performance of mMIMO MU-MIMO transmission with mobile UEs or highly dynamic environment. Data driven approaches are promising way to solve the problem as they can learn the channel complexity for in the environment of interest. However, some solutions rely on training the models for a given set of UE mobility speeds, e.g., due to the limited available data, and inherent difficulty to train on all possible speeds. As a result, these trained models struggle to generalize to higher speeds.

The present disclosure provides solutions to this problem from different angles, (i) appropriate model utilization, with or without signaling assistance, and (ii) method to enhance model training: (1) using a shifted window vision transformer for wireless channel prediction, including calculating attention scores among different channel pixels to enhance the quality of the extracted features, wherein a shifted window operation improves efficiency of the shifted window vision transformer; and (2) combining SRS prediction with channel interpolation to enhance a system performance at high speed when a channel coherence time is less than SRS periodicity.

In one embodiment, the provided method comprises: a multi-step CSI prediction module and a CSI interpolation module.

The present disclosure provides a channel prediction method and apparatus for massive MIMO (mMIMO) systems with mobility. Various embodiments of the present disclosure apply a window attention signal processing method on wireless channel instances to efficiently extract the correlation patterns that are important in predicting the future channel information.

The SRS is an uplink reference signal that is used for uplink channel acquisition. A periodic SRS setting meaning that the UE is transmitting SRS in a periodic manner is provided. By processing the received SRS, the BS is able to estimate the CSI, based on which the subsequent functionalities (such as scheduling, precoding, etc.) can be executed.

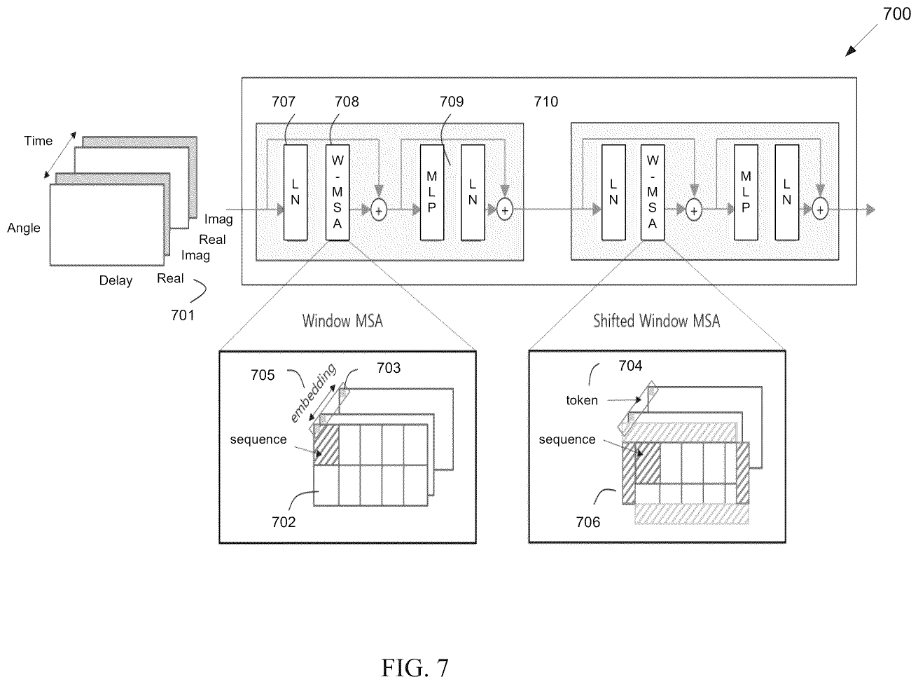

FIG. 7 illustrates an example of shifted window attention 700 according to various embodiments of the present disclosure. An embodiment of the shifted window attention 700 shown in FIG. 7 is for illustration only.

The SRS channel has its original form in the antenna-frequency domain in a MIMO-OFDM system, while some approaches oftentimes suggest that it is more efficient when processing the CSI samples in the delay-angle domain for full utilization of the possible sparse structure. The acquired SRS channel samples may be transformed into delay-angle domain for further processing. Moreover, the complex-valued SRS channel matrix is provided at a given time as a 2D image, with angle dimension representing the height of the image and the delay dimension representing the width. A number of “color channels” of such image is 2, which comprises the real and imaginary components of the complex-valued matrix. The SRS channels at different time steps are stacked along the image color channel dimension and are ordered alternatively as real-imaginary planes in 701 as illustrated in FIG. 7.

Window attention mechanism starts by partitioning the 2D image into multiple non-overlapping windows in 702. Each window is set to certain height and width that are deemed as hyperparameters of the model. Empirical evidence shows that the selection of the window size may have influence on the performance. On one hand, if the window size is too small, the attention calculation is restricted to a highly localized region, which may result in unsatisfactory performance. On the other hand, if the window size is too large, overfitting could occur as a result of lacking training data.

Each window further comprises multiple patches that, in general, contain a group of “image pixels.” In the present disclosure, a special case is provided when each image patch contains only single pixel (e.g., 703). The justifications for doing so are mainly two-fold. First, it is in general beneficial to have less pixels within a patch, as this normally implies a higher resolution in processing the image information, i.e., to achieve pixel-level tasks. However, when the dimension of the image is large, such method leads to high processing complexity. Since the channel image is oftentimes with reasonable size, it is affordable to conduct signal processing in this manner. Second, in the considered channel prediction problem, each pixel of the channel image represents the channel coefficient from a certain angle and at a certain delay tap. Therefore, different pixels may be processed separately in order to capture their mutual relationship.

The main idea of the window attention is to perform attention calculation within each window. In the context of vision transformer, each patch is regarded as one token in (e.g., 704). To be more specific, for a given pixel of the image, its real and imaginary values are used, along with its values in the history (i.e., its values in the past SRS channels) as its embedding vector (e.g., 705). As can be inferred, such embedding contains useful information about the channel behavior at that certain angle and delay tap. After the embedding, the standard multi-head self-attention calculation may be performed on the patches within the window, and different windows may be processed independently.

In another embodiment of the present disclosure, the architecture, inherited from the original Swin transformer, is called shifted window attention. Shifted window attention is provided as a way to enlarge the receptive field of the model. Specifically, as illustrated in FIG. 7, all the windows in the standard window attention module may be shifted along a common direction in (e.g., 706). The “new” windows may have some overlapping with the “old windows,” i.e., certain patches may appear in both new and old windows. As a result, the effective attention calculation region may be the union of two overlapping windows.

Apart from the window attention, the overall architecture of Swin transformer is similar to the vanilla transformer architecture. Specifically, the input signal is first passed to a layer normalization (LN) layer (e.g., 707), after which the window multi-head self-attention layer is employed to process the signal (e.g., 708). At the end, a multi-layer perceptron (MLP) together with another LN layer are utilized to further process the signal (e.g., 709). A pair of standard window attention module and shifted window attention module constitute the building block of the Swin transformer layer (STL) in (e.g., 710). In one embodiment, the “module” can be implemented as a software, hardware, or firmware.

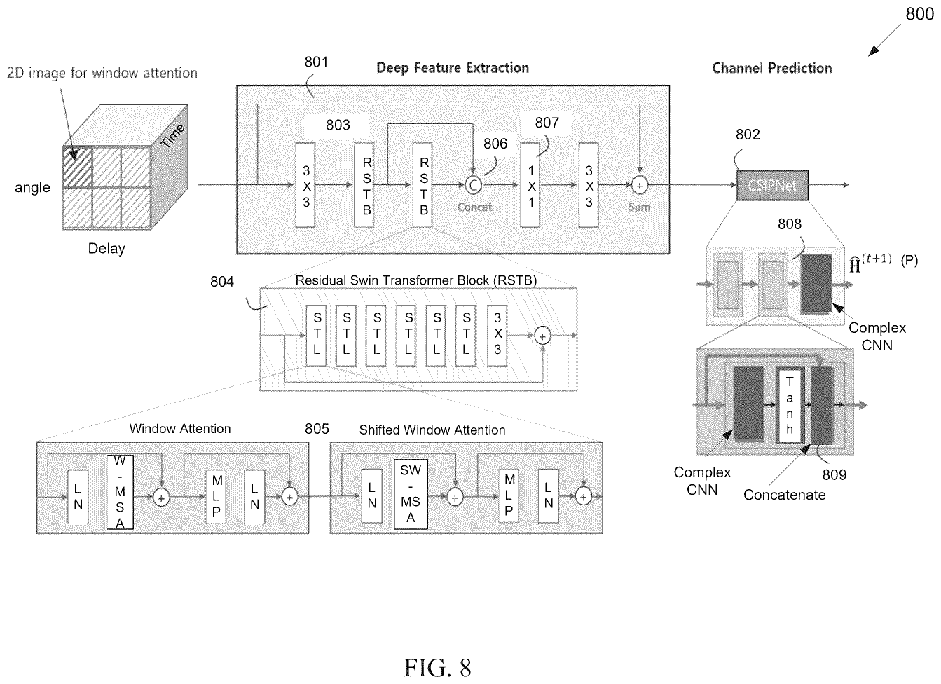

FIG. 8 illustrates an example of a general structure of CSI prediction model 800 according to various embodiments of the present disclosure. An embodiment of the general structure of CSI prediction model 800 shown in FIG. 8 is for illustration only.

FIG. 8 illustrates the general structure of the provided CSI prediction model. Roughly speaking, the prediction network is comprised of a deep feature extraction (DFE) module (e.g., 801) and a CSI adaptation module, which can be realized by, e.g., a CNN architecture, e.g., a 3 layer CSIPNet with residual connections (e.g., 802).

The DFE module presents a deep structure and is employed to extract useful representations of the CSI samples. In the current design, it comprises 2 residual Swin transformer blocks (RSTBs) in (e.g., 803). Each RSTB is further a stack of 6 STLs (e.g., 804). It is worth highlighting that the number of STLs in a RSTB is also a hyperparameter, and it is closely related to the depth of the network. In general, deep networks are preferred as they can produce high quality features for the subsequent processing. Similar to the window size, though, one may balance between the model size and the available training samples to prevent overfitting from happening.

Each STL is a pair of window attention and shifted window attention blocks (e.g., 805), as introduced before. To briefly recapitulate, window attention blocks process the channel samples in the angle-delay domain, and view them as 2D images. The time dimension along with the real/imaginary parts of the complex-valued channel coefficient are regarded as the embedding of each pixel of the delay-angle channel image.

Moreover, as can be observed from FIG. 8, the skip connections are employed ubiquitously in the provided architecture to fully leverage the benefits from residual learning, as well as to enable deep expansion of the network. Another important design is the feature map concatenation (e.g., 806), where the feature maps generated by the first RSTB may be concatenated with the feature maps generated by the second RSTB. Such feature map concatenation achieves better learning results than sequentially processing the feature maps from one block to another. The following CNN layer with 1-by-1 kernel is leveraged to bring back the original number of feature maps produced by one RSTB in (e.g., 807).

As mentioned in the present disclosure, the DFE aims to learn the useful representations of the raw CSI samples. After that, a CSIPNet is adopted to predict the future CSI based on these high-quality feature maps. The CSIPNet is a pile of 3 complex-CNN (CCNN) layers (e.g., 808). The CCNN layer may treat temporal and spatial (both horizontal and vertical dimensions of the UPA panel) channels as 3D images, and may process the two polarization independently. Similar feature map concatenation (e.g., 809) is also used within the CSIPNet that empirically shows improved performance.

The input of the prediction model is a sequence of observed SRSs. They are equally spaced in the time domain with certain pilot periodicity (i.e., SRS or CSI-RS periodicities). Before these raw CSI samples are processed by the network, a channel conversion and normalization are provided within the sequence. Specifically, a 2D-FFT (i.e., 1D-FFT operated separately on the horizontal and vertical dimension of the UPA) is used to transform the antenna domain channel into the angular domain. After that, another 1D-IFFT is utilized to transform the frequency domain channel into the delay domain. The transformed channel samples may then be normalized to be within a reasonable range which can be efficiently processed by the prediction network. It is worth highlighting that the calculated normalization factor may be recorded, as it may be applied to the predicted channel to scale back to the original channel power level.

The network presented so far has a focus on predicting on a one-step CSI (e.g., SRS or CSI-RS) method. Simply put, it is future CSI that is one periodicity away from the most updated SRS locally available. In practical scenarios, however, it is oftentimes essential to perform multi-step (that extends longer into the future) SRS prediction to produce more room to account for severe system processing delay (that is larger than one SRS periodicity). By leveraging the model presented above, two ways to achieve such objective are provided.

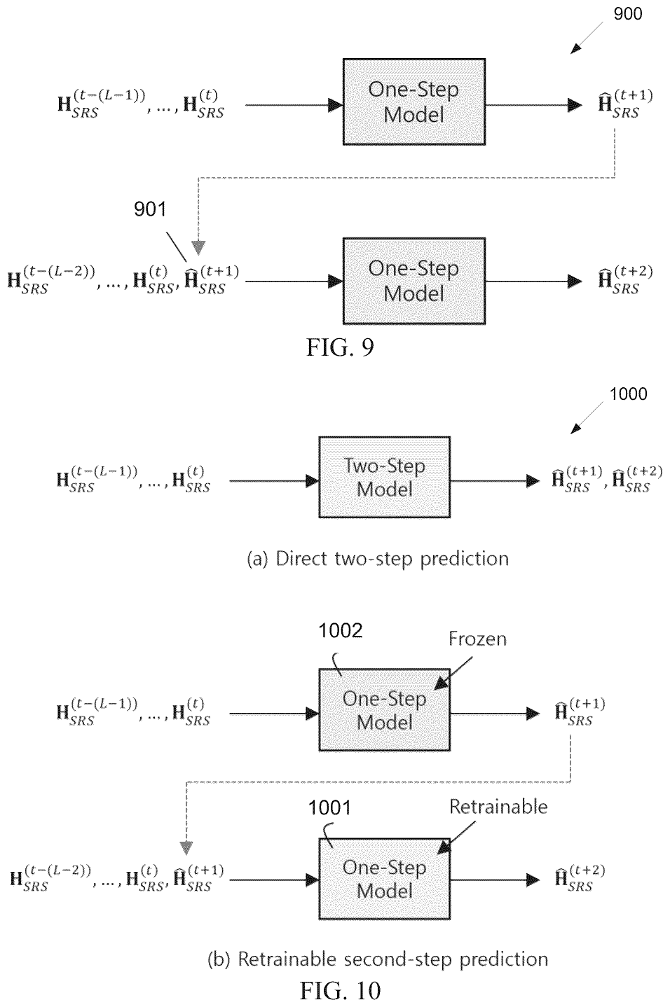

FIG. 9 illustrates an example of two-step prediction model 900 according to various embodiments of the present disclosure. An embodiment of the two-step prediction model 900 shown in FIG. 9 is for illustration only.

In one embodiment, the trained one-step prediction model is recursively used. This method uses the well-trained one-step prediction model to generate the multi-step SRS predictions. As illustrated in FIG. 9 (where a two-step prediction is provided as an example to highlight the key idea), the output of the model may be circled back and concatenated with the input sequence to form another input sequence that resembles the “ground truth” input for predicting the second future SRS (e.g., 901). This method maintains the complexity of one-step prediction while being able to generate, ideally, arbitrarily long future SRS sequence. In particular, it may work well if the one-step prediction can maintain certain level of accuracy.

FIG. 10 illustrates examples of direct two-step prediction model and retrainable second-step prediction 1000 according to various embodiments of the present disclosure. An embodiment of the direct two-step prediction model and retrainable second-step prediction 1000 shown in FIG. 10 is for illustration only.

In one embodiment, direct prediction of multi-step future SRSs is provided. This method aims to have a dedicated model that performs the multi-step SRS predictions. It may perform model retraining (e.g., the trained one-step model may not be immediately reusable), and can be implemented in different manners. Two example training solutions are provided to highlight the idea.

The first solution could be developing a dedicated model with output being multiple future SRSs, as depicted in FIG. 10 (e.g., (a) as illustrated in FIG. 10), where a two-step prediction is provided as an example. This essentially increases the output dimension of the problem and can be viewed as a direct generalization of one-step prediction.

The second solution could be based upon one-step model. Specifically, the well-trained one-step model may be used for predicting second future SRS. However, instead of using it recursively, another network may be connected to it for predicting the second SRS, as shown in FIG. 10 (e.g., (b) as illustrated in FIG. 10). This new network may be retrained using the second future SRS (e.g., 1001) and the one-step model may be frozen during this process (e.g., 1002). This process can be executed recursively to generate multiple future SRS predictions.

In addition to the future SRS prediction, it is important to provide a transmission time interval (TTI) level channel information between the SRSs (or channel interpolation), where the actual transmissions are scheduled. The TTI channels have major effect on the overall system performance, such as throughput, and is the ultimate objective of channel prediction. To address such problem, an AI-based channel interpolation method is provided.

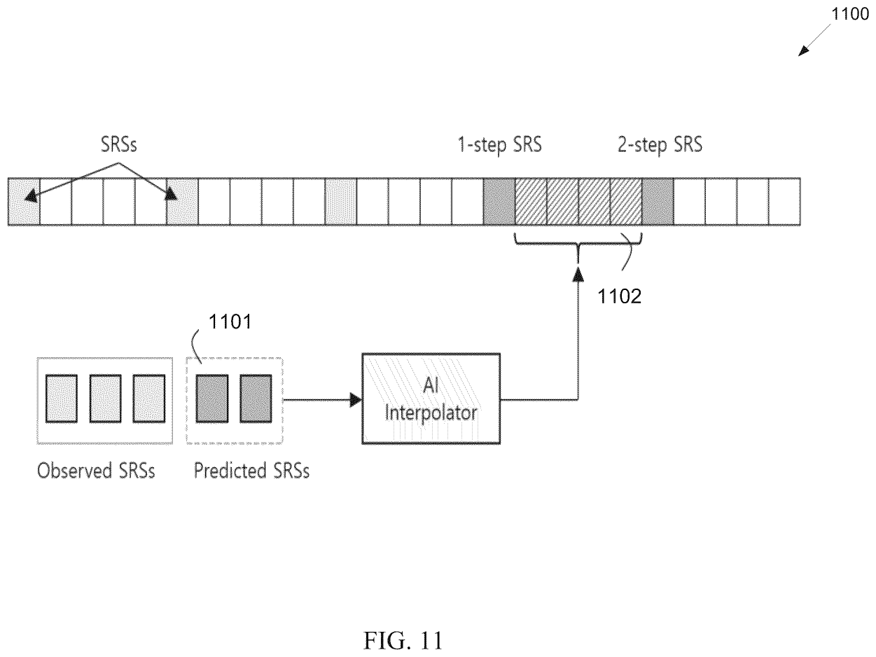

FIG. 11 illustrates an example of TTI level prediction 1100 according to various embodiments of the present disclosure. An embodiment of the TTI level prediction 1100 shown in FIG. 11 is for illustration only.

As illustrated in FIG. 11, the predicted multi-step future SRSs can be leveraged to generate the TTI channels between them. Generally speaking, the predicted future SRSs may be concatenated with the past SRS sequence (e.g., 1101), and the elongated SRS sequence may be passed to a dedicated AI model to generate the per TTI channels between the two future SRSs (e.g., 1102). The provided framework holds the possibility of predicting a subset of the TTI channels in between. The advantage of this method is that it opens up the possibilities to combine other channel prediction methods with the developed channel interpolator. This provides more flexibility during the deployments. Moreover, depending on the operating conditions, certain modifications can be applied to balance the overall complexity.

When the UE is at low speed, or more accurately, the SRS periodicity is small enough to capture the channel variations, universal interpolation methods (such as linear interpolation, cubic, spline interpolation, etc.) can be used. These methods are normally with low complexity and can yield close to optimal performance under the low mobility condition.

When the UE is at high speed, or more accurately, the SRS periodicity is not small enough to capture the fast temporal channel variations, more advanced channel interpolation method is required to learn the intricate evolution patterns. For these scenarios, an embodiment using AI-based method to generate the TTI channels based on past and predicted SRS channel information is provided.

The mentioned embodiments in the present disclosure can be implemented in the base station's modem to deliver accurate channel prediction based on past channel state information, thereby increasing the overall system performance such as coverage and throughput.

In one embodiment, enabling accurate channel prediction is critical for massive MIMO systems and it has broad use cases: (i) enabling robust MU-MIMO system with improved cell throughput performance and (ii) enhancing the communication for high dynamic systems, e.g., vehicular to everything (V2X), which is crucial for applications such as autonomous driving, etc.

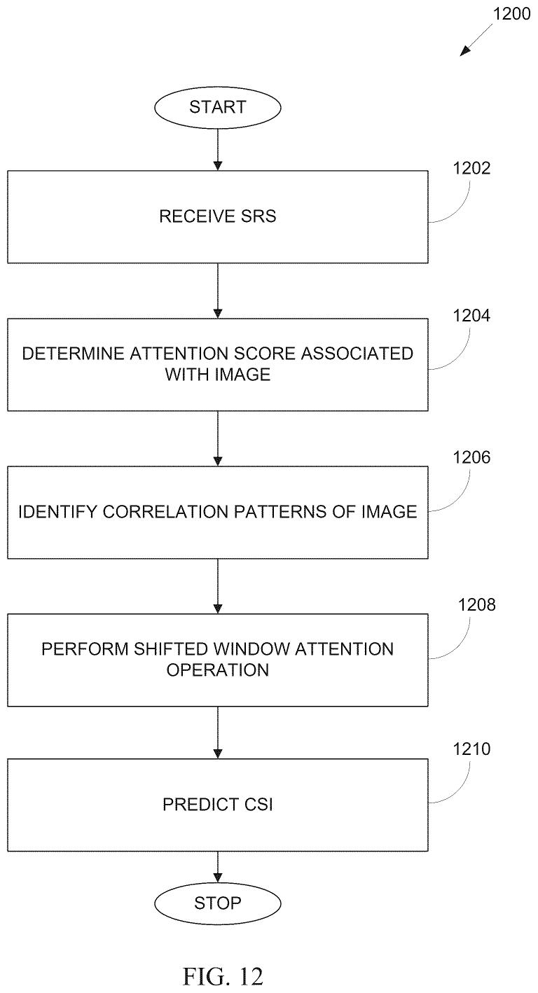

FIG. 12 illustrates a flowchart of BS method 1200 for a high speed CSI prediction using a shifted window transformer according to various embodiments of the present disclosure. The BS method 1200 as may be performed by a BS (e.g., 101-103 as illustrated in FIG. 1). An embodiment of the BS method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, the BS method 1200 begins at step 1202. In step 1202, the BS receives an SRS.

Subsequently, in step 1204, the BS determines, based on channel pixels including an angle and a delay, at least one attention score associated with an image.

Subsequently, in step 1206, the BS identifies, based on the at least one attention score, correlation patterns of the images.

Next, in step 1208, the BS performs, based on the correlation patterns, a shifted window attention operation for uplink channel estimation. In one example, the shifted window attention operation comprises repeated window attention operations corresponding to a residual shifted window transformer for performing a residual learning.

Finally, in step 1210, the BS predicts, based on the shifted window attention operation, CSI from the SRS for the uplink channel estimation. In one example, the shifted window attention operation is performed based on segmentations of the image and each segmentation of the image is used for a linear projection of flattened patches of a transformer encoder.

In one embodiment, the BS identifies a window size for the repeated window attention operations and performs each repeated window operation in a half of the window size to increase an attention region of the image.

In one embodiment, the BS predicts the SRS based on at least one of a recursive prediction operation, a retrainable prediction operation, or a direct prediction operation. In such embodiments, the recursive prediction operation includes a trained prediction operation that is recursively used to generate multiple SRS predictions. In such embodiments, the retrainable prediction operation includes a retrained prediction operation that is used to generate second-step SRS predictions. In such embodiments, the direct prediction operation includes single trained prediction operations that are used to generate multiple SRS predictions (e.g., to generate multiple SRS predictions at once).

In one embodiment, the BS performs an SRS prediction operation and a channel interpolation operation to predict the CSI. In such embodiments, the channel interpolation operation uses the SRS and predicted SRS from the SRS. In such embodiments, a channel coherence time is less than an SRS periodicity for the SRS prediction operation.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive a sounding reference signal (SRS); and
a processor operably coupled with the transceiver, the processor configured to:
determine, based on channel pixels including an angle and a delay, at least one attention score associated with an image,
identify, based on the at least one attention score, correlation patterns of the images,
perform, based on the correlation patterns, a shifted window attention operation for uplink channel estimation, and
predict, based on the shifted window attention operation, channel state information (CSI) from the SRS for the uplink channel estimation.

2. The BS of claim 1, wherein the shifted window attention operation comprises repeated window attention operations corresponding to a residual shifted window transformer for performing a residual learning.

3. The BS of claim 2, wherein the processor is further configured to:
identify a window size for the repeated window attention operations; and
perform each repeated window operation in a half of the window size to increase an attention region of the image.

4. The BS of claim 1, wherein:
the shifted window attention operation is performed based on segmentations of the image; and
each segmentation of the image is used for a linear projection of flattened patches of a transformer encoder.

5. The BS of claim 1, wherein:
the processor is further configured to predict the SRS based on at least one of a recursive prediction operation, a retrainable prediction operation, or a direct prediction operation;
the recursive prediction operation includes a trained prediction operation that is recursively used to generate multiple SRS predictions;
the retrainable prediction operation includes a retrained prediction operation that is used to generate second-step SRS predictions; and
the direct prediction operation includes single trained prediction operations that are used to generate multiple SRS predictions at once.

6. The BS of claim 1, wherein:
the processor is further configured to perform an SRS prediction operation and a channel interpolation operation to predict the CSI; and
the channel interpolation operation uses the SRS and predicted SRS from the SRS.

7. The BS of claim 6, wherein a channel coherence time is less than an SRS periodicity for the SRS prediction operation.

8. A method of a base station (BS) in a wireless communication system, the method comprising:
receiving a sounding reference signal (SRS);
determining, based on channel pixels including an angle and a delay, at least one attention score associated with an image;
identifying, based on the at least one attention score, correlation patterns of the images,
performing, based on the correlation patterns, a shifted window attention operation for uplink channel estimation; and
predicting, based on the shifted window attention operation, channel state information (CSI) from the SRS for the uplink channel estimation.

9. The method of claim 8, wherein the shifted window attention operation comprises repeated window attention operations corresponding to a residual shifted window transformer for performing a residual learning.

10. The method of claim 9, further comprising:
identifying a window size for the repeated window attention operations; and
performing each repeated window operation in a half of the window size to increase an attention region of the image.

11. The method of claim 8, wherein:
the shifted window attention operation is performed based on segmentations of the image; and
each segmentation of the image is used for a linear projection of flattened patches of a transformer encoder.

12. The method of claim 8, further comprising predicting the SRS based on at least one of a recursive prediction operation, a retrainable prediction operation, or a direct prediction operation, wherein:
the recursive prediction operation includes a trained prediction operation that is recursively used to generate multiple SRS predictions;
the retrainable prediction operation includes a retrained prediction operation that is used to generate second-step SRS predictions; and
the direct prediction operation includes single trained prediction operations that are used to generate multiple SRS predictions at once.

13. The method of claim 8, further comprising performing an SRS prediction operation and a channel interpolation operation to predict the CSI,
wherein the channel interpolation operation uses the SRS and predicted SRS from the SRS.

14. The method of claim 13, wherein a channel coherence time is less than an SRS periodicity for the SRS prediction operation.

15. A non-transitory computer-readable medium comprising program code, that when executed by at least one processor, causes an electronic device to:
receive a sounding reference signal (SRS);
determine, based on channel pixels including an angle and a delay, at least one attention score associated with an image;
identify, based on the at least one attention score, correlation patterns of the images;
perform, based on the correlation patterns, a shifted window attention operation for uplink channel estimation; and
predict, based on the shifted window attention operation, channel state information (CSI) from the SRS for the uplink channel estimation.

16. The computer-readable medium of claim 15, wherein the shifted window attention operation comprises repeated window attention operations corresponding to a residual shifted window transformer for performing a residual learning.

17. The computer-readable medium of claim 16, further comprising program code, that when executed by at least one processor, causes an electronic device to:
identify a window size for the repeated window attention operations; and
perform each repeated window operation in a half of the window size to increase an attention region of the image.

18. The computer-readable medium of claim 15, wherein:
the shifted window attention operation is performed based on segmentations of the image; and
each segmentation of the image is used for a linear projection of flattened patches of a transformer encoder.

19. The computer-readable medium of claim 15, further comprising program code, that when executed by at least one processor, causes an electronic device to predict the SRS based on at least one of a recursive prediction operation, a retrainable prediction operation, or a direct prediction operation, wherein:
the recursive prediction operation includes a trained prediction operation that is recursively used to generate multiple SRS predictions;
the retrainable prediction operation includes a retrained prediction operation that is used to generate second-step SRS predictions; and
the direct prediction operation includes single trained prediction operations that are used to generate multiple SRS predictions at once.

20. The computer-readable medium of claim 15, further comprising program code, that when executed by at least one processor, causes an electronic device to perform an SRS prediction operation and a channel interpolation operation to predict the CSI, wherein:
the channel interpolation operation uses the SRS and predicted SRS from the SRS; and
a channel coherence time is less than an SRS periodicity for the SRS prediction operation.
